(19) United States
(12) Patent Application Publication
(10) Pub. No.: US 2012/0167037 A1
(43) Pub. Date: Jun. 28, 2012

(54) SOFTWARE STATIC TESTING APPARATUS AND METHOD

(75) Inventors: Sa-Choun PARK, Gunpo-si (KR); Jeong-Hwan Kim, Daejeon (KR)

(73) Assignee: ELECTRONICS AND TELECOMMUNICATIONS RESEARCH INSTITUTE, Daejeon-city (KR)

(21) Appl. No.: 13/300,019

(22) Filed: Nov. 18, 2011

(30) Foreign Application Priority Data
Dec. 23, 2010 (KR) 10-2010-0133945

(51) Int. Cl. G06F 11/36; G06F 9/44

(52) U.S. Cl. 717/107

(57) ABSTRACT

A software static testing apparatus generates code by integrating a plurality of source files corresponding to automotive software, creates logical expressions for the code and a test case, and performs testing of the plurality of source files using a resulting logical expression obtained by using the logical expression for the code and the logical expression for the test case.

### CROSS REFERENCE TO RELATED APPLICATION

This application claims the benefit of Korean Patent Application No. 10-2010-0133945, filed on Dec. 23, 2010, which is hereby incorporated by reference in its entirety into this application.

### BACKGROUND OF THE INVENTION

1. Technical Field

The present invention relates generally to a software static testing apparatus and method. More particularly, the present invention relates to a software static testing apparatus and method, which are configured to automate configuration inspection.

2. Description of the Related Art

Software testing is classified into static testing and dynamic testing. Dynamic testing is a type of a software testing method which directly executes implemented software and determines whether the results of the execution are identical to desired expected values. Static testing is a type of software testing method which tests software without actually executing software.

Static testing is generally performed by configuration inspection, source code inspection, a compile-build process, etc.

Configuration inspection is configured to inspect whether configuration values violate constraints. When software is created, the input of exact values for several variables may be occasionally delayed, and configuration denotes the assignment of specific values to configuration variables.

When a program is created, several variable or constant values may be configured so that they influence the compiling or execution of the program. The variable or constant values configured in this way are called the configuration of a relevant program, wherein configuration inspection is a method of inspecting whether the configuration has been consistently implemented according to the intent.

Source code inspection is the activity of inspecting source code for errors, and is configured to determine whether the signature of a method has been created according to the specification, or inspect whether program variables or header files to be compiled are suitably present.

A compile-build process is the activity of reporting errors that occur during compiling and taking action against the occurrence of errors.

Most of these static testing methods have been performed to date using manual operations. However, model-based development methods are introduced to large-scale software development such as in automotive fields, so that pieces of source code are automatically generated, and, in particular, the configuration of programs is automatically generated using a configuration tool. As a result, as targets to be configuration-inspected have greatly increased, an automation tool for static testing is required.

Furthermore, when there is a relationship existing so that the configuration of one variable influences the configuration of another variable while configuration variables which are to be configuration-inspected are located in different files, it is very difficult to detect errors manually, and thus the automation of static testing is urgently required.

### SUMMARY OF THE INVENTION

Accordingly, the present invention has been made keeping in mind the above problems occurring in the prior art, and an object of the present invention is to provide a software static testing apparatus and method, which enable the inspection of configuration source files to be automated.

In accordance with an aspect of the present invention, there is provided a software static testing method, the method being performed by an apparatus, including generating code by integrating a plurality of source files corresponding to automotive software, creating a logical expression for the code, creating a logical expression for a pre-stored test case, generating a resulting logical expression using the logical expression for the code and the logical expression for the test case, and performing testing of the plurality of source files using the resulting logical expression.

In accordance with another aspect of the present invention, there is provided a software static testing method, the method being performed by an apparatus, including generating code by integrating a plurality of source files corresponding to automotive software, extracting code information including names of variables and parameters contained in the code, creating a binary expression for a pre-stored test case, extracting test case information including names of variables and parameters contained in the binary expression, generating testing code in which the binary expression is inserted into the code by using both the code information and the test case information, and performing testing of the plurality of source files using the testing code.

In accordance with a further aspect of the present invention, there is provided a software static testing apparatus, including a preprocessing unit, a control unit and a processing unit. The preprocessor unit generates an integrated code by integrating a plurality of configuration source files corresponding to automotive software. The control unit creates a logical expression for the code by parsing the code, and creates a testing logical expression by using the logical expression for the code and a logical expression for a pre-stored test case. The processing unit inspects whether the testing logical expression is true, and then generates results of testing the plurality of configuration source files.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the construction of an automotive software system according to an embodiment of the present invention;

FIG. 2 is a diagram showing the construction of a software static testing apparatus according to an embodiment of the present invention;

FIG. 3 is a flowchart showing a software static testing method according to a first embodiment of the present invention; and

FIG. 4 is a flowchart showing a software static testing method according to a second embodiment of the present invention.

### DESCRIPTION OF THE PREFERRED EMBODIMENTS

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

Hereinafter, a software static testing apparatus and method according to embodiments of the present invention will be described with reference to the attached drawings.

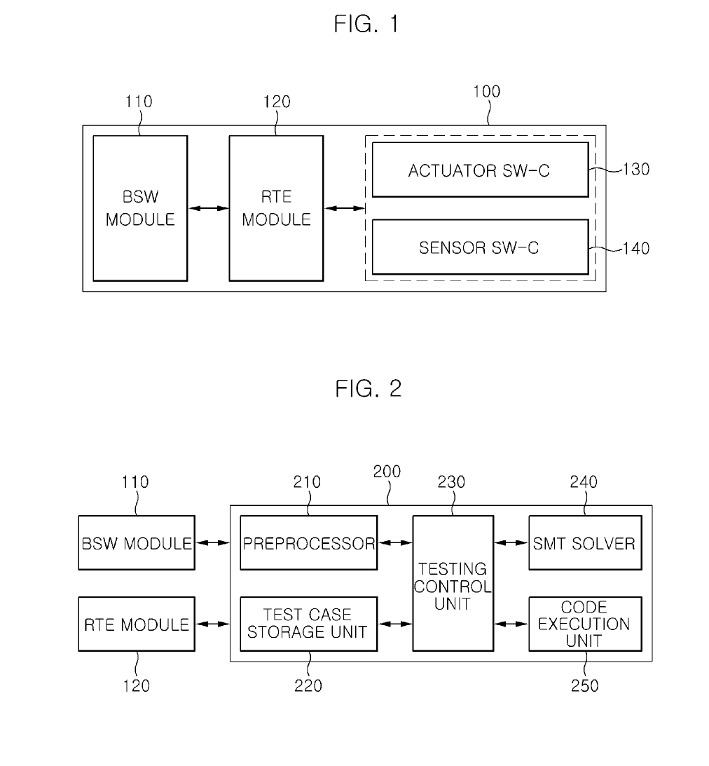

First, an automotive software system according to an embodiment of the present invention will be described with reference to FIG. 1.

FIG. 1 is a diagram showing the construction of an automotive software system according to an embodiment of the present invention.

As shown in FIG. 1, an automotive software system 100 conforms to an AUTomotive Open System Architecture (hereinafter also referred to as an “AUTOSAR”), and includes a basic software module (hereinafter also referred to as a “BSW module”) 110, a runtime environment module (hereinafter also referred to as an “RTE module”) 120, and a plurality of software components. Here, the plurality of software components may include an actuator software component (hereinafter also referred to as an “Actuator SW-C”) 130 and a sensor software component (hereinafter also referred to as a “Sensor SW-C”) 140.

Here, AUTOSAR is a standard software platform for automotive electric and electronic systems to pursue the improvement of software reusability and scalability by separating hardware from software, and defines a model-based development methodology.

The BSW module 110 is software related to automotive hardware, that is, an electronic control unit (hereinafter also referred to as an “ECU”), and is automatically generated from models depending on the predefined model-based development methodology. In this regard, the BSW module 110 includes configuration code corresponding to dynamic code, and function code corresponding to static code. Here, the configuration code corresponds to code, that is, “*.h” or “*.c”, generated using a model-based configuration tool.

The runtime environment module 120 functions to exchange information between the BSW module 110 and the plurality of software components, and is configured to provide an environment in which application services independent of hardware can be developed by separating the hardware-related BSW module 110 from the plurality of software components corresponding to application software.

A plurality of software components, which are basic units mapped to the ECU, constitute part of the functions of application software, define signals and data to be transmitted or received through ports and interfaces, and exchange messages using the operations of tasks depending on a defined standard.

The actuator software component 130 is a software component for implementing the actuator of the electronic control unit (ECU).

The sensor software component 140 is a software component for implementing the sensor of the ECU.

Hereinafter, a software static testing apparatus according to an embodiment of the present invention will be described in detail with reference to FIG. 2.

FIG. 2 is a diagram showing the construction of a software static testing apparatus according to an embodiment of the present invention.

As shown in FIG. 2, a software static testing apparatus 200 inspects the conformance of a plurality of configuration source files received from the basic software module 110 and the runtime environment module 120 of the automotive software system 100. The software static testing apparatus 200 includes a preprocessor 210, a test case storage unit 220, a testing control unit 230, a satisfiability modulo theory solver (hereinafter also referred to as an “SMT solver”) 240, and a code execution unit 250. Here, the software static testing apparatus 200 performs software static testing on the configuration files of a plurality of files that constitute the basic software module 110 or the runtime environment module 120.

The preprocessor 210 generates a single piece of preprocessed code by integrating files required for testing, that is, the plurality of configuration source files. In this case, the preprocessed code is not a typical type of program having control flow, and is composed of structures which assign values to variables and assignment statements which use arrays.

The test case storage unit 220 stores a plurality of test cases for testing conformance. In this regard, the test case storage unit 220 may store logical expressions for the respective test cases, as shown in the following Table 1.

TABLE 1

| Test Cases | Logical Expression |
|---|---|
| TC_CANNM_0005 | CanNmPassiveModeEnabled = true → CanNmBusLoadReductionEnabled = |
| | false |
| TC_CANNM_0009 | CanNmPassiveModeEnabled = true [symbol] CanNmImmediateRestartEnabled = |
| | false |
| TC_CANNM_0010 | CanNmPassiveModeEnabled = true [symbol] CanNmImmediateTxconfEnabled = |
| | false |
| TC_CANNM_0014 | CanNmPassiveModeEnabled = true [symbol] CanNmBusSynchronizationEnabled |
| | = false |
| | [symbol] CanNmBusLoadReductionEnabled = false [symbol] |
| | CanNmNodeDetectionEnabled = false [symbol] CanNmRemoteSleepIndEnabled |
| | = false |
| TC_CANNM_0022 | CanNmBusLoadReductionEnabled = true [symbol] |
| | CanNmBusLoadReductionActive = true |
| TC_CANNM_0025 | CanNmMsgReducedTime > CanNmMsgCycleTime/2 |
| | CanNmMsgCycleTime > CanNmMsgReducedTime |
| TC_CANNM_0028 | CanNmPduCbvPosition = CANM_PDU_OFF [symbol] CanNmPduNidPosition ≠ |
| | CanNmPduCbvPosition |
| TC_CANNM_0030 | ∃nεN−n×CanNmMsgCycleTime = CanNmRemoteSleepIndTime |
| TC_CANNM_0031 | ∃nεN−n×CanNmMsgCycleTime = CanNmRepeatMessageTime |
| | CanNmNodeDetectionEnabled = true → CanNmRepeatMessageTime > 0 |
| TC_CANNM_0032 | ∃nεN−CanNmTimeoutTime = n×CanNmMsgCycleTime |
| TC_CANNM_0033 | CanNmPduCbvPosition = CANNM_PDU_OFF [symbol] CanNmPduNidPosition = |
| | CANNM_PDU_OFF → CanNmUserDataLength ≦ 8 |
| | (CanNmPduCbvPOSition = CANNM_PDU_BYTE_0 [symbol] CanNmPduNidPositIon = |
| | CANNM_PDU_OFF) [symbol] (CanNmPduNidPosition = CANNM_PDU_BYTE_0 [symbol] |
| | CanNmPduCbvPosition = CANNM_PDU_OFF) > CanNmUserDataLength ≦ 7 |
| | (CanNmPduCbvPOSition = CANNM_PDU_BYTE_1 [symbol] CanNmPduNidPositIon = |
| | CANNM_PDU_BYTE_1) [symbol] CanNmUserDataLength ≦ 6 |

The testing control unit 230 generates input for the SMT solver 240 or the code execution unit 250 using the preprocessed code and the test cases. Here, the testing control unit 230 may convert the preprocessed code into a logical expression and may convert each test case into a logical expression or a binary expression. In this case, the testing control unit 230 may generate input for the SMT solver 240 using the logical expressions for the preprocessed code and for the test case. Further, the testing control unit 230 may also generate input for the code execution unit 250 using binary expressions for the preprocessed code and for the test case.

The testing control unit 230 may parse the preprocessed code and then convert the name, value and assignment of each variable into logical expressions. For example, each of a plurality of configuration source files may include a head file conforming to the following Pseudo Code 1.

| | |
|---|---|
| Typedef struct{ | |
| L | |
| Int restart; | (1) |
| L | |
| } GlobalConfig | |

Further, each of the plurality of configuration source files may include configuration code conforming to the following Pseudo Code 2.

| | |
|---|---|
| GlobalConfig ={ | |
| #ifdef MODE | |
| L | |
| 0 /* value corresponding to restart variable*/ | (2) |
| L | |
| #else | |
| L | |
| } | |

In this case, the testing control unit 230 may create a logical expression given by the following Pseudo Code 3 from the preprocessed code that includes the header file conforming to Pseudo Code 1 and the configuration code conforming to Pseudo Code 2.

Restart=0

MODE=true (3)

The testing control unit 230 may convert a test case written in a structurized natural language into a logical expression. For example, the test case storage unit 220 may include the test case conforming to the following Pseudo Code 4.

Restart should be set to false if Mode=true (4)

In this case, the testing control unit 230 may create a logical expression given by the following Pseudo Code 5 from the test case conforming to Pseudo Code 4.

(Mode=true) [symbol] (Restart=0) (5)

In this case, the testing control unit 230 may create a binary expression given by the following Pseudo Code 6 from the test case conforming to Pseudo Code 4.

(Mode !=true) & (Restart==0) (6)

The testing control unit 230 may create a changed binary expression given by the following Pseudo Code 7 by changing the names of the variables, contained in the binary expression given by Pseudo Code 6, using the preprocessed code.

(Mode !=true) & (GlobalConfig->Restart==0) (7)

The SMT solver 240 determines a solution of the logical expression represented by a combination of background theories, inspects whether the logical expression input from the testing control unit 230 is satisfiable, and then generates the results of the testing of the plurality of configuration source files. In this case, the SMT solver 240 determines whether the relevant test is successful or failed depending on the results of the inspection, that is, whether the logical expression is true or not.

The code execution unit 250 executes the code input from the testing control unit 230, and generates the results obtained by testing the plurality of configuration source files. In this case, the code execution unit 250 may execute the input code after compiling the input code.

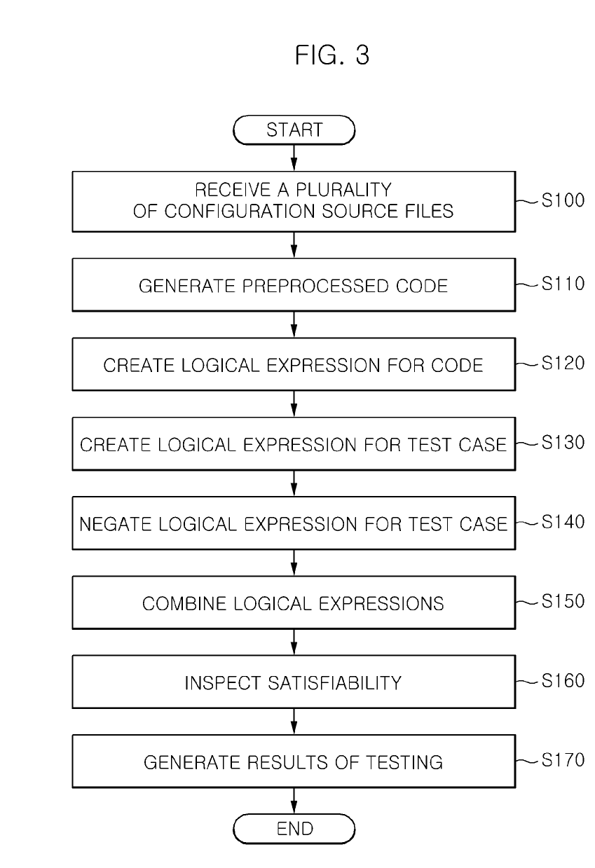

Next, a software static testing method according to a first embodiment of the present invention will be described in detail with reference to FIG. 3.

FIG. 3 is a flowchart showing a software static testing method according to a first embodiment of the present invention.

As shown in FIG. 3, the software static testing apparatus 200 receives a plurality of configuration source files from the basic software module 110 and the runtime environment module 120 of the automotive software system 100 at step S100.

Next, the preprocessor 210 generates preprocessed code by integrating the plurality of configuration source files into a single file at step S110.

The testing control unit 230 creates a logical expression for the preprocessed code at step S120.

The testing control unit 230 creates a logical expression for any one of a plurality of test cases stored in the test case storage unit 220 at step S130.

Thereafter, the testing control unit 230 negates the logical expression for the test case to create a negative logical expression at step S140.

The testing control unit 230 combines the logical expression for the preprocessed code with the negative logical expression, and then creates a query logical expression corresponding to the input of the SMT solver 240 at step S150. In this case, the testing control unit 230 may combine the logical expression for the preprocessed code with the negative logical expression using a logical conjunction (logical AND).

Thereafter, the SMT solver 240 inspects whether the query logical expression is true and then generates the results of the inspection indicative of “satisfaction” (true) or “dissatisfaction” (false) at step S160.

Next, the SMT solver 240 generates the results of testing corresponding to a success or a failure depending on the results of the inspection at step S170.

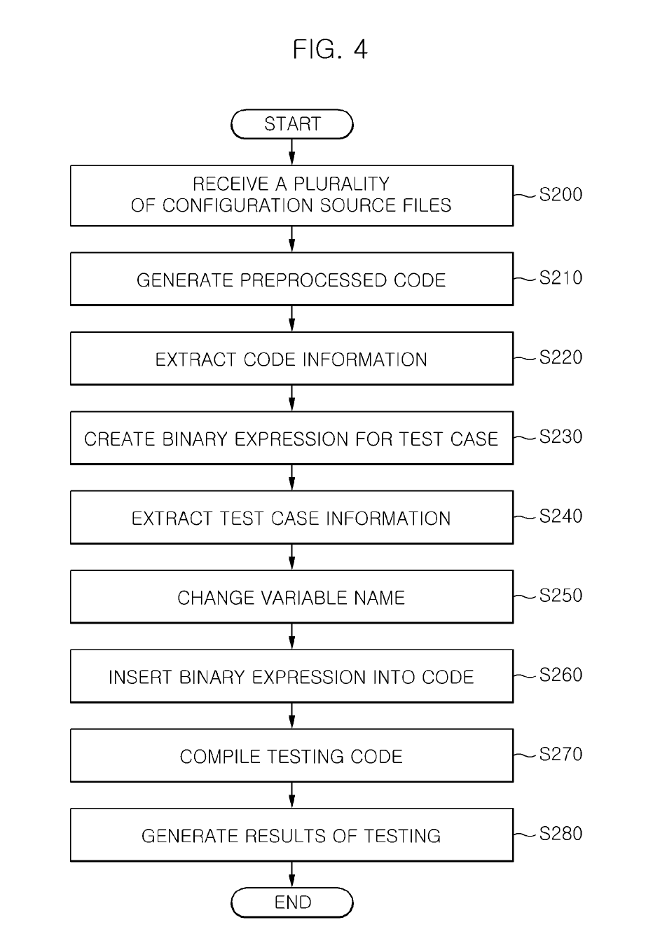

Hereinafter, a software static testing method according to a second embodiment of the present invention will be described in detail with reference to FIG. 4.

FIG. 4 is a diagram showing a software static testing method according to a second embodiment of the present invention.

As shown in FIG. 4, the software static testing apparatus 200 receives a plurality of configuration source files from the basic software module 110 and the runtime environment module 120 of the automotive software system 100 at step S200.

The preprocessor 210 generates preprocessed code by integrating the plurality of configuration source files into a single file at step S210.

The preprocessor 210 extracts, from the preprocessed code, code information including the names of variables and parameters that are contained in the preprocessed code at step S220.

The testing control unit 230 creates a binary expression for any one of a plurality of test cases stored in the test case storage unit 220 at step S230.

Thereafter, the testing control unit 230 extracts, from the binary expression for the test case, test case information including the names of variables and parameters that are contained in the binary expression for the test case at step S240.

Next, the testing control unit 230 changes the names of the variables contained in the binary expression for the test case to the names of the variables contained in the preprocessed code using both the code information and the test case information, and then makes the variable names the same at step S250.

Thereafter, the testing control unit 230 generates testing code by inserting the changed binary expression into the preprocessed code at step S260. In this case, the testing control unit 230 may insert the changed binary expression into the main function of the preprocessed code by using an “if˜then statement”.

Next, the code execution unit 250 compiles the testing code at step S270.

The code execution unit 250 executes the compiled testing code and generates the results of testing corresponding to a success or a failure depending on the results of the execution at step S280.

As described above, although embodiments of the software static testing apparatus and method related to the automotive software system have been disclosed in the drawings and the present specification, the present invention is not limited to those embodiments. Further, those skilled in the art will appreciate that the present invention can also be equally applied to software static testing in other fields.

According to the present invention, there are advantages in that configuration inspection for inspecting whether the configuration of complicated variables has been consistently implemented according to the intent in various fields using a plurality of types of application software, such as in vehicles, web programs, mobile phones and aircraft, is automated, so that software quality can be improved, and the development efficiency of a software developer can be improved thanks to a reduction in the number of tasks performed when testing software.

As described above, optimal embodiments of the present invention have been disclosed in the drawings and the present specification. In this case, although specific terms have been used, those terms are merely intended to describe the present invention and are not intended to limit the meanings and the scope of the present invention as disclosed in the accompanying claims. Therefore, those skilled in the art will appreciate that various modifications and other equivalent embodiments are possible from the above-description. Therefore, the technical scope of the present invention should be defined by the technical spirit of the accompanying claims.

What is claimed is:

1. A software static testing method, comprising:
generating code by integrating a plurality of source files corresponding to automotive software;
creating a logical expression for the code;
creating a logical expression for a pre-stored test case;
generating a resulting logical expression using the logical expression for the code and the logical expression for the test case; and
to performing testing of the plurality of source files using the resulting logical expression.

2. The software static testing method of claim 1, wherein the performing the testing is configured to perform testing for the resulting logical expression using a processor for inspecting whether a relevant logical expression is true.

3. The software static testing method of claim 2, wherein the performing the testing is configured to determine results of testing depending on whether the resulting logical expression is true.

4. The software static testing method of claim 1, wherein the generating comprises:
creating a negative logical expression corresponding to the logical expression for the test case; and
combining the logical expression for the code with the negative logical expression.

5. The software static testing method of claim 4, wherein the combining the logical expression for the code with the negative logical expression is configured to combine the logical expression for the code with the negative logical expression using a logical conjunction.

6. The software static testing method of claim 1, wherein the plurality of source files comprise environment configuration values for automotive hardware.

7. The software static testing method of claim 1, wherein the creating the logical expression for the code is configured to parse the code and create a logical expression corresponding to a name, a value and assignment of a variable contained in the code.

8. A software static testing method, comprising:
generating code by integrating a plurality of source files corresponding to automotive software;
extracting code information including parameters and names of variables contained in the code;
creating a binary expression for a pre-stored test case;
extracting test case information including parameters and names of variables contained in the binary expression;
generating testing code in which the binary expression is inserted into the code by using both the code information and the test case information; and
performing testing of the plurality of source files using the testing code.

9. The software static testing method of claim 8, wherein the generating the testing code comprises:
changing the names of the variables contained in the binary expression to the names of the variables contained in the code using both the code information and the test case information; and
generating the testing code by inserting the changed binary expression into the code.

10. The software static testing method of claim 9, wherein the generating the testing code by inserting the changed binary expression into the code is configured to insert the changed binary expression into a function contained in the binary expression.

11. The software static testing method of claim 8, wherein the performing the testing is to configured to execute the testing code and generate results of testing corresponding to results of the execution.

12. A software static testing apparatus, comprising:
a preprocessing unit for generating an integrated code by integrating a plurality of configuration source files corresponding to automotive software;
a control unit for creating a logical expression for the code by parsing the code, and creating a testing logical expression by using the logical expression for the code and a logical expression for a pre-stored test case; and
a processing unit for inspecting whether the testing logical expression is true, and then generating results of testing the plurality of configuration source files.

13. The software static testing apparatus of claim 12, wherein the control unit creates a negative logical expression corresponding to the logical expression for the test case, and combines the logical expression for the code with the negative logical expression using a logical conjunction.

14. The software static testing apparatus of claim 13, wherein the results of the testing comprise information related to whether the testing of the plurality of configuration source files is successful.

15. The software static testing apparatus of claim 12, further comprising an execution unit for executing testing code in which a pre-stored binary expression is inserted into the code, and generating the results of the testing.

16. The software static testing apparatus of claim 15, wherein the control unit inserts the binary expression into the code using code information including names of variables and parameters contained in the code, thus generating the testing code.

17. The software static testing apparatus of claim 16, wherein the control unit changes the names of the variables contained in the binary expression to the names of the variables contained in the code using the code information, and inserts the changed binary expression into the code.

18. The software static testing apparatus of claim 15, wherein the binary expression is a binary expression for the pre-stored test case.
